(19) United States
(12) Patent Application Publication
(10) Pub. No.: US 2022/0237008 A1
(43) Pub. Date: Jul. 28, 2022

(54) EMBEDDED COMPUTATION INSTRUCTION SET OPTIMIZATION

(71) Applicant: Seagate Technology LLC, Fremont, CA (US)

(72) Inventor: Marc Tim JONES, Longmont, CO (US)

(21) Appl. No.: 17/156,344

(22) Filed: Jan. 22, 2021

(51) Int. Cl. G06F 9/455; G06F 9/30

(52) U.S. Cl. CPC G06F 9/4552; G06F 9/30043; G06F 9/3017; G06F 9/30101

(57) ABSTRACT

The technology disclosed herein pertains to a system and method for providing optimization of embedded computation instruction set (CIS), the method including downloading the CIS to a computational storage device (CSD), committing the CIS to a program slot in a computational storage processor of the CSD, simulating execution of the CIS at the committed slot to generate static analysis of one or more registers of the CIS to determine ranges of values that the one or more registers can take through a lifecycle of the CIS, demoting one or more of the registers to lower size registers, and generating a native instruction set from the CIS based on the register demotions.

### BACKGROUND

A computational storage device (CSD) is a storage device that provides persistent data storage and computational services. Computational storage is about coupling compute and storage to run applications locally on the data, reducing the processing required on the remote server, and reducing data movement. To do that, a processor on the drive is dedicated to processing the data directly on that drive, which allows the remote host processor to work on other tasks. Berkeley Packet Filter (BPF) is a technology used in certain CSD systems for processing data. It provides a raw interface to data link layers, permitting raw link-layer packets to be sent and received. eBPF (or Enhanced Berkeley Packet Filter) describes an computing instruction set (CIS) that has been selected for drive-based computational storage.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

The technology disclosed herein pertains to a system and method for providing optimization of an embedded computation instruction set (CIS), the method including downloading the CIS to a computational storage device (CSD), committing the CIS to a program slot in a computational storage processor of the CSD, simulating execution of the CIS at the committed slot to generate static analysis of one or more registers of the CIS to determine ranges of values that the one or more registers can take through a lifecycle of the CIS, demoting one or more of the registers to lower size registers, and generating a native instruction set from the CIS based on the register demotions.

These and various other features and advantages will be apparent from a reading of the following Detailed Description.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates a schematic diagram of an example system for optimizing an embedded computing instruction set (CIS) on a computational storage device (CSD).

FIG. 2 illustrates an alternative schematic diagram of an example system for optimizing an embedded computing instruction set (CIS) on a computational storage device (CSD).

FIG. 3 illustrates example operations for optimizing an embedded computing instruction set (CIS) on a computational storage device (CSD).

FIG. 4 illustrates alternative example operations for optimizing an embedded computing instruction set (CIS) on a computational storage device (CSD).

FIG. 5 illustrates an example processing system that may be useful in implementing the described technology.

### DETAILED DESCRIPTION

A computational storage device (CSD) is a storage device that provides persistent data storage and computational services. Computational storage is about coupling compute and storage to run applications locally on the data, reducing the processing required on the remote server, and reducing data movement. To do that, a processor on the drive is dedicated to processing the data directly on that drive, which allows the remote host processor to work on other tasks. Berkeley Packet Filter (BPF) is a technology used in certain CSD systems for processing data. It provides a raw interface to data link layers, permitting raw link-layer packets to be sent and received. eBPF (or Enhanced Berkeley Packet Filter) describes an computing instruction set (CIS) that has been selected for drive-based computational storage.

eBPF is a relatively simple instruction set, but covers instructions necessary for complex program development. eBPF may be interpreted on the target device or translated into the native instruction set for performance (since interpretation is ultimately slower than native execution. However, in some implementations, eBPF is suboptimal for translation to modern embedded processors such as ARM, RISC-V, etc., which makes it less than ideal for computational storage applications.

Some implementations of the CSD disclosed herein may implement interpretation of the eBPF instructions on the native architecture, which represents the slowest form of computational storage. Alternative implementations may implement translation where the eBPF instructions are translated into the native instruction set of the computational storage processors such as ARM, RISC-V, etc. The technology disclosed herein is directed to using a computational instruction set (CIS) such as the eBPF within the CSD and optimizing the eBPF before generating a native instruction set (such as an ARM instruction set, an RISC instruction set, etc.). Specifically, the implementations disclosed herein provide for performing statis analysis of the eBPF during a simulation to determine range of values that various registers of the eBPF take and performing type demotion for those registers that can safely be represented in lower size registers (such as 64-bit registers that can be represented in 32-bit registers, etc).

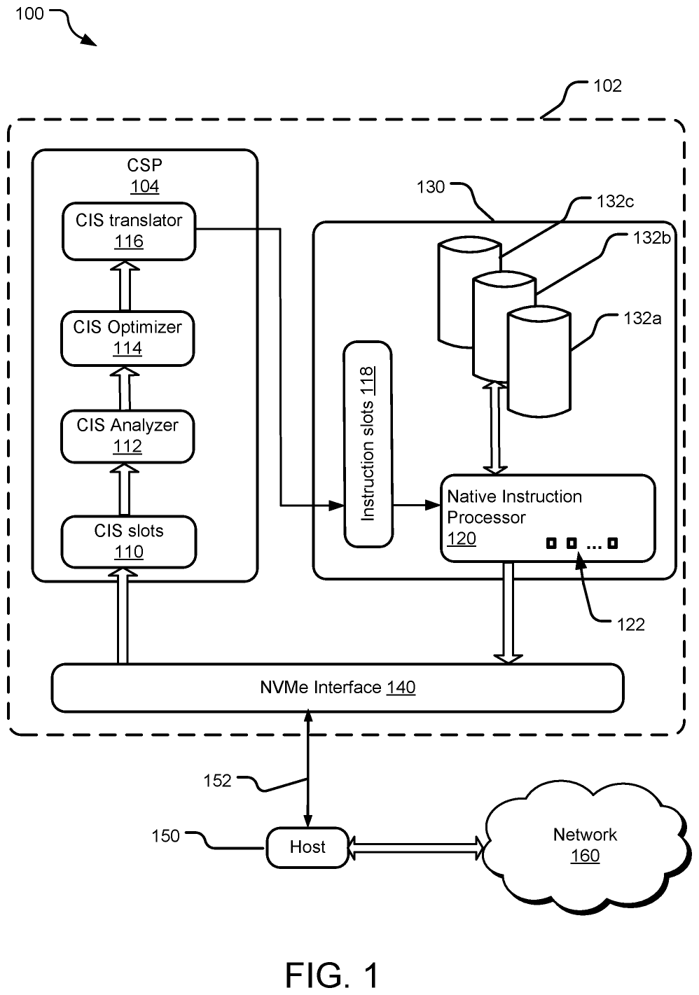

FIG. 1 illustrates a schematic diagram of a system 100 for optimizing an embedded computing instruction set (CIS) on a computational storage device (CSD) 102. The CSD 102 may include a memory 130 implemented using hard disc drives (HDDs), solid state drives (SSDs), hybrid drives, etc. In the illustrated implementation, the memory 130 is implemented using HDDs 132a-132c (HDDs 132). The CSD 102 allows processing data on the HDDs 132 where the data is stored, enabling the generation of insights and value directly from the data stored on the HDDs 132. Such smart processing of data at the CSD 102 reduced the movement of large amounts of data to external processing and delivers numerous benefits including reduced latency, reduced bandwidth usage, increased security, energy savings, etc.

The CSD 102 provides such processing of data at the storage by using a computational storage processor (CSP) 104 working with the memory 130. The CSD 102 may include an interface to communicate with a host 150. For example, such an interface is an NVMe interface 140 that communicates with the host 150 using a PCIe interface 152. The host 150 may be a server or other computing system that maybe implemented in the vicinity of the CSD 102 and may be communicatively connected to a network 160, such as the Internet.

The host 150 may receive from the network 150 or develop one or more computing instruction sets (CISs) for processing data on the CSD 102. An example of such as CIS is an enhanced Berkeley Packet Filter (eBPF). The CISs may provide interface to the data on the memory 130 at the data link layer and may be configured to process the data at the data link layer. The NVMe interface 140 may download such CIS from the host using a download command such as an NVMe download command. Once the NVMe interface 140 downloads one or more CIS from the host 150, the CIS is stored at a CIS slot 110 on the CSP 104.

A CIS analyzer 112 may analyze the CIS by simulating the processing of the CIS. Specifically, the CIS analyzer 112 may be implemented using various computer program instructions that may be processed on a CPU or other processor. As part of CIS analysis, the CIS analyzer 112 may perform a static analysis and/or a value range analysis to identify a range of values that variables of the CIS may take during its lifecycle of the CIS.

As an example, if an access tracking variable of the CIS that is configured so measure the number of times a times a given HDD of the HDDs 132 is accessed in a predetermined time period, the CIS analyzer 112 performs the simulations to determine the range of values that such an access tracking variable may take. For example, the CIS analyzer may determine that the maximum values of the access tracking variable is such that is may be stored in a 32 bit register. Alternatively, the CIS analyzer 112 may determine that the maximum values of the access tracking variable is such that is may not be stored in a 32 bit register and therefore, it requires a 64 bit register. As an alternative example, if a variable of the CIS is used as an index into memory, the CIS analyzer 112 identifies the bounds of this variable. In response to determining the upper bound of this variable, the CIS analyzer 112 verifies whether the CIS variable can be stored in a 32-bit register instead of a 64-bit register. Alternatively, the CIS analyzer 112 may determine that the upper bound of the CIS variable is such that it may not be stored in a 32 bit register and therefore, it requires a 64 bit register.

Such analysis helps in optimizing the use of registers 122 available to a native instruction processor 120. For example, the native instruction processor may be an ARM instruction processor, an RISC instruction processor, etc. In such an implementation, the registers 122 may be 32-bit registers. Alternatively, the registers 122 may be 16-bit registers, 32-bit registers, 64-bit registers, or a combination of such different size registers. In one implementation, the CIS analyzer 112 applies value range analysis to the 64-bit variables of the CIS, that is variables that are designed for 64-bit registers, to determine the range of values that these 64-bit variables may take over the lifecycle of the CIS. If, for example, the entire 64-bits are required during the lifecycle of the CIS, then the CIS analyzer 112 assumes two 32-bit registers 122 may be used to represent the single 64-bit CIS variable in the translation process. But if the value for the CIS variable requires only 32-bits or less for representation through the lifecycle, then only a single 32-bit register 122 is used, which conserves the precious register space 122 that exists in the native instruction processor 120, such as an ARM processor, an RISC-V processor, etc. Thus, such analysis helps conserve use of the registers 122.

In an alternative implementation, the CIS analyzer 112 also analyzes the frequency of use of one or more of the CIS variables that are to be stored using the registers 122. In such an implementation, the information about the frequency of the use of such CIS variables may be prioritize the assignment of 64-bit CIS variables to registers 122, such as the native instruction set (such as ARM) 32-bit registers. For example, two 64-bit CIS variables may be found to be used at different rates, with variable R1 being used at a much higher frequency than variable R2. In such a case, the CIS optimizer 114 may determine that R1 is applied to two 32-bit registers 122 and R2 is to be applied to memory. Such variable to register allocation yields higher efficiency in use of the registers 122. Specifically, placing the more frequently used register in register space means it's not in memory, which has higher latency in access, and therefore results in better performance.

Once the allocation of the CIS variables to the registers 122 is determined, a CIS translator 116 translates the modified CIS to native instruction set, such as an instruction set for an ARM processor, an instruction set for an RISC-V processor, etc. The native instruction set is allocated to instruction slots 118 to operate on the native instruction processor 120 to process data from the memory 130.

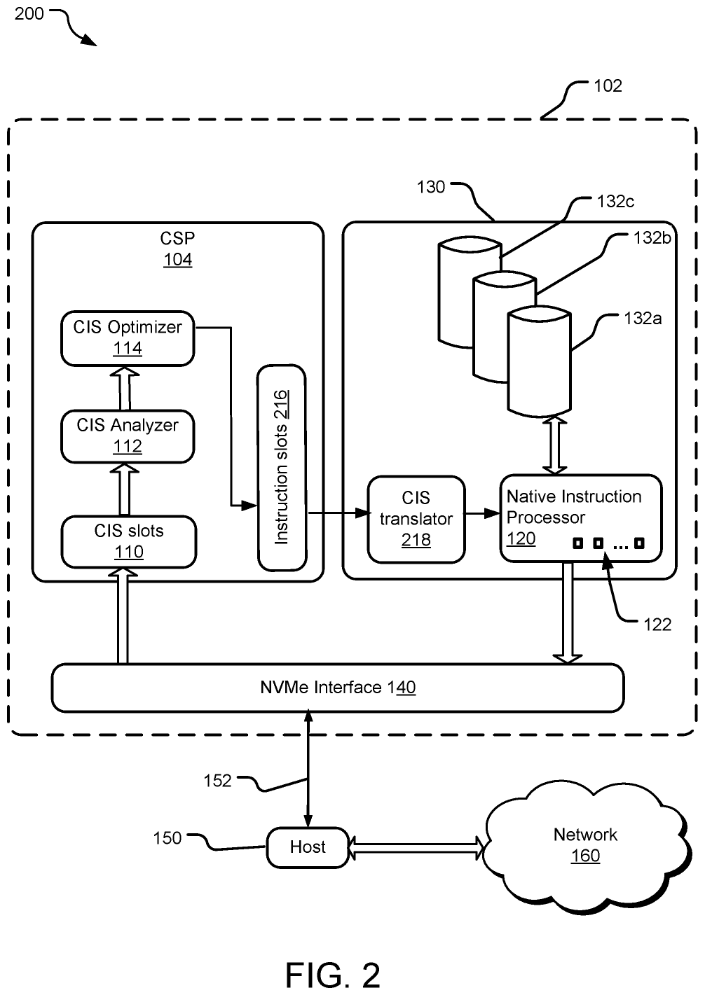

FIG. 2 illustrates an alternative schematic diagram of a system 200 for optimizing an embedded computing instruction set (CIS) on a computational storage device (CSD). One or more features of the system 200 are substantially similar to the elements of respective system 100 disclosed in FIG. 1. However, while for system 100, the optimized CIS is translated to native instruction set before being allocated to native instruction slots 118, in the system 200, the optimized CIS is allocated to CIS instruction slots 216 and subsequently it is translated by a CIS translator 218 in real time for the native instruction processor 120.

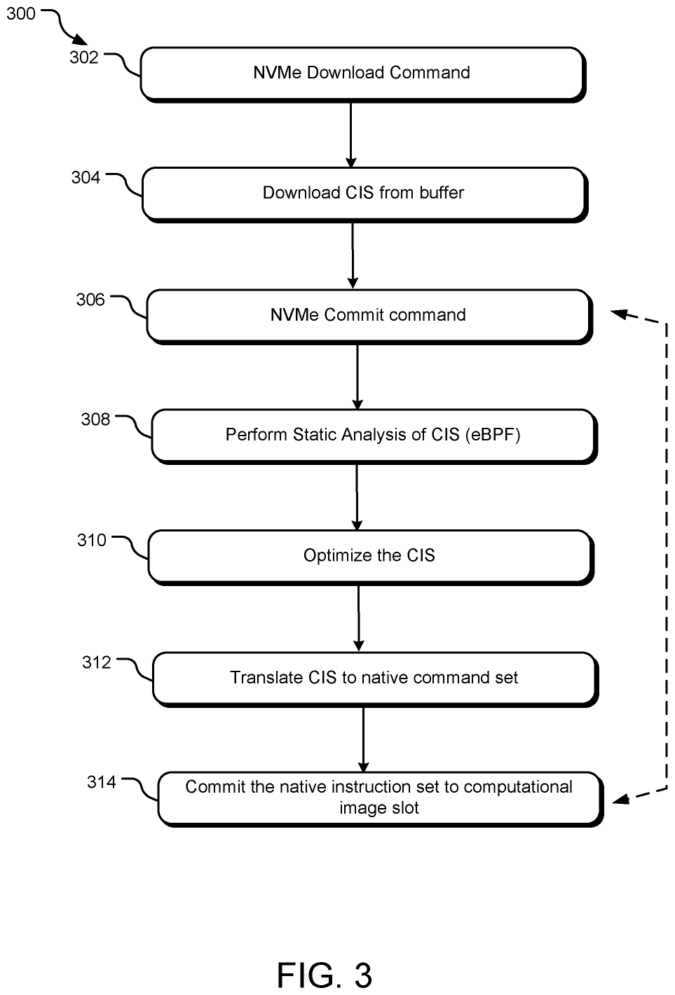

FIG. 3 illustrates example operations 300 for optimizing an embedded computing instruction set (CIS) on a computational storage device (CSD). An operation 302 issues an NVME download command. At operation 304 a CIS, such as an eBPF is downloaded from a host to an NVMe buffer of the CSD. Once the CIS is downloaded, at operation 306 an NVMe commit command is used to commit the CIS to a CIS slot in a computational storage processor, such as the CSP 104. In an alternative implementation, the CIS not committed to a CIS slot, but alternatively a program in the native instruction set is committed to a native instruction slot, such as the instruction slots 118, at operation 314.

Subsequently, an operation 308 performs static analysis of the CIS. Such statis analysis may involve data flow analysis over the life cycle of the CIS execution to determine range of variable taken by the CIS variable, the frequency of use of the CIS variables, etc. Subsequently, an operation 310 optimizes the CIS by demoting one or more CIS variables to smaller size register. For example, the operation 310 may demote one or more variables that do not assume values beyond 32-bit range to 32-bit registers. Alternatively, the operation 310 may demote or more CIS variables with use below a predetermined frequency to memory instead of native instruction processor registers.

Furthermore, such optimizations may also include, constant folding, load/store optimization, operation strength reduction, and null sequence elimination (such as removing JMP +0 instructions which a CLANG/LLVM compiler does generate), etc. After the optimization, an operation 312 translates the CIS to a native instruction set, such as an ARM instruction set, etc.

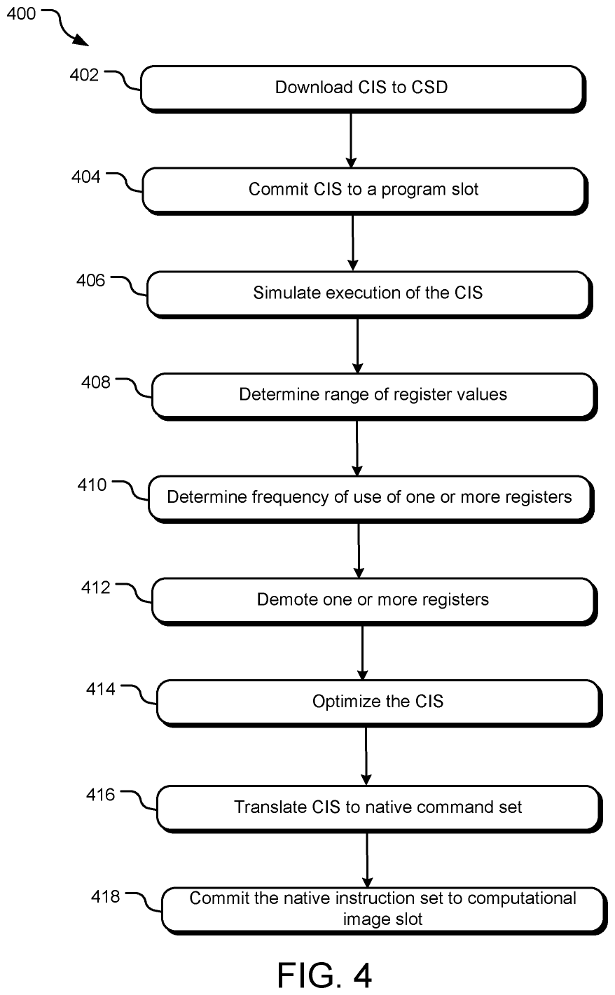

FIG. 4 illustrates alternative example operations 400 for optimizing an embedded computing instruction set (CIS) on a computational storage device (CSD). An operation 402 downloads a CIS to a CSD. For example, such download may be accomplished by executing an NVMe download command. An operation 404 commits the CIS to a CIS program slot by, for example, using an NVMe commit command. Subsequently an operation 406 simulates execution of the CIS. For example, such simulation may include executing the CIS a predetermined number of times and collecting the range of values taken by various CIS variables.

An operation 408 determines the range of values that various CIS variables may assume over the lifecycle. Similarly, an operation 410 may determine the frequency of use of various CIS variables during the lifecycle of the CIS. Based on the range analysis and the frequency of use analysis, an operation 412 demotes one or more CIS variables to a lower bit register. For example, if two CIS variables takes values that may be represented by 16-bit registers, such two CIS variables may be demoted to be represented by a single 32-bit native instruction processor register. Similarly, if a CIS variable is used below a predetermined number of times during the lifecycle of the CIS, such CIS variable may be demoted to be stored in a RAM instead of in a native instruction processor register.

An operation 412 may perform one or more other optimizations on the CIS. For example, such optimizations may include, constant folding, load/store optimization, operation strength reduction, and null sequence elimination (such as removing JMP+0 instructions which a CLANG/LLVM compiler does generate), etc. An operation 416 translates the optimized CIS with one or more demoted or promoted CIS variable to a native command set, such as a native command set for an ARM processor, a native command set for an RISC-V processor, etc. An operation 418 commits the native instruction set to a computational image slot, such as the instruction slots 118 disclosed in FIG. 1.

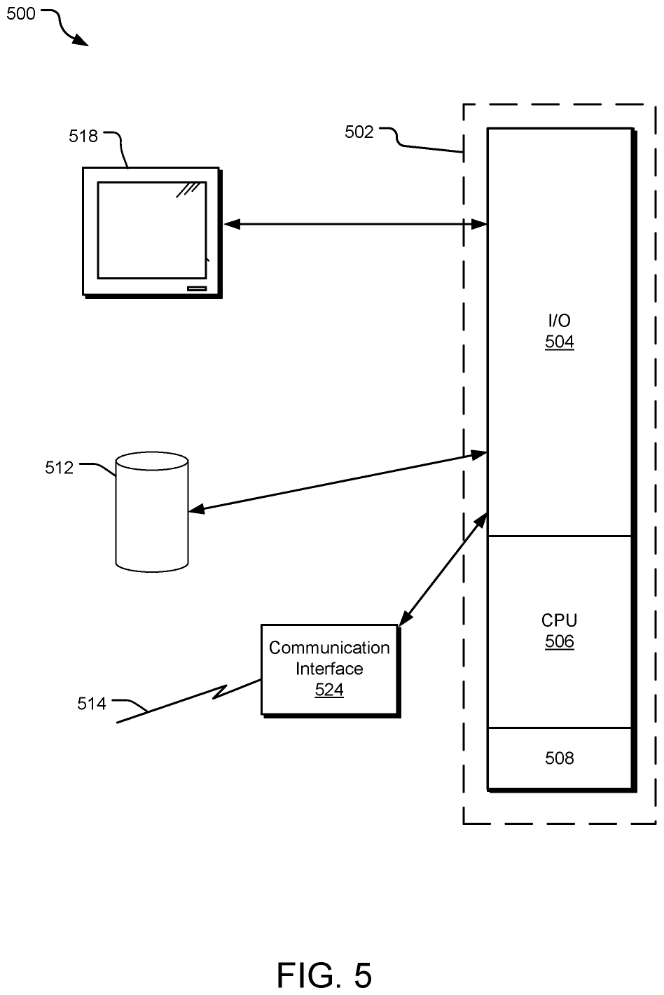

FIG. 5 illustrates an example processing system 500 that may be useful in implementing the described technology. The processing system 500 is capable of executing a computer program product embodied in a tangible computer-readable storage medium to execute a computer process. Data and program files may be input to the processing system 500, which reads the files and executes the programs therein using one or more processors (CPUs or GPUs). Some of the elements of a processing system 500 are shown in FIG. 5 wherein a processor 502 is shown having an input/output (I/O) section 504, a Central Processing Unit (CPU) 506, and a memory section 508. There may be one or more processors 502, such that the processor 502 of the processing system 500 comprises a single central-processing unit 506, or a plurality of processing units. The processors may be single core or multi-core processors. The processing system 500 may be a conventional computer, a distributed computer, or any other type of computer. The described technology is optionally implemented in software loaded in memory 508, a storage unit 512, and/or communicated via a wired or wireless network link 514 on a carrier signal (e.g., Ethernet, 3G wireless, 8G wireless, LTE (Long Term Evolution)) thereby transforming the processing system 500 in FIG. 5 to a special purpose machine for implementing the described operations. The processing system 500 may be an application specific processing system configured for supporting a distributed ledger. In other words, the processing system 500 may be a ledger node.

The I/O section 504 may be connected to one or more user-interface devices (e.g., a keyboard, a touch-screen display unit 518, etc.) or a storage unit 512. Computer program products containing mechanisms to effectuate the systems and methods in accordance with the described technology may reside in the memory section 508 or on the storage unit 512 of such a system 500.

A communication interface 524 is capable of connecting the processing system 500 to an enterprise network via the network link 514, through which the computer system can receive instructions and data embodied in a carrier wave. When used in a local area networking (LAN) environment, the processing system 500 is connected (by wired connection or wirelessly) to a local network through the communication interface 524, which is one type of communications device. When used in a wide-area-networking (WAN) environment, the processing system 500 typically includes a modem, a network adapter, or any other type of communications device for establishing communications over the wide area network. In a networked environment, program modules depicted relative to the processing system 500 or portions thereof, may be stored in a remote memory storage device. It is appreciated that the network connections shown are examples of communications devices for and other means of establishing a communications link between the computers may be used.

In an example implementation, a user interface software module, a communication interface, an input/output interface module, a ledger node, and other modules may be embodied by instructions stored in memory 508 and/or the storage unit 512 and executed by the processor 502. Further, local computing systems, remote data sources and/or services, and other associated logic represent firmware, hardware, and/or software, which may be configured to assist in supporting a distributed ledger. A ledger node system may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 508 and/or the storage unit 512 and executed by the processor 502.

The processing system 500 may be implemented in a device, such as a user device, storage device, IoT device, a desktop, laptop, computing device. The processing system 500 may be a ledger node that executes in a user device or external to a user device.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A method, comprising:
downloading a computation instruction set (CIS) to a computational storage device (CSD);
committing the CIS to a program slot in a computational storage processor of the CSD;
simulating execution of the CIS at the committed slot to generate static analysis of one or more registers of the CIS to determine ranges of values that the one or more registers can take through a lifecycle of the CIS;
demoting one or more of the registers to lower size registers; and
generating a native instruction set from the CIS based on the register demotions.

2. The method of claim 1, wherein the CIS is an enhanced Berkeley Packet Filter (eBPF) instruction set.

3. The method of claim 1, wherein the native instruction set is one of ARM instruction set and an RISC instruction set.

4. The method of claim 1, wherein demoting one or more of the registers to lower size registers comprising demoting one or more 64-bit registers to a 32-bit register.

5. The method of claim 1, further comprising storing the native instruction set to a just-in-time native virtual machine of the CSD.

6. The method of claim 1, further comprising optimizing the CIS using frequency of use of the one or more registers of the CIS.

7. The method of claim 6, further comprising optimizing the CIS using at least one of (a) constant folding, (b) load/store optimization, (c) operation strength reduction, and (d) null sequence elimination before generating the native instruction set from the CIS.

8. A system, comprising:
a storage device;
a non-volatile memory express (NVMe) interface to communicate with a host; and
a computation system controller (CSC) to store one or more computer program instructions executable on a processor, the computer program instructions comprising:
downloading a computation instruction set (CIS) to a computational storage device (CSD);
simulating execution of the CIS at a committed slot to generate static analysis of one or more registers of the CIS to determine ranges of values that the one or more registers can take through a lifecycle of the CIS;
demoting one or more of the registers to lower size registers; and
generating a native instruction set from the CIS based on the register demotions.

9. The device of claim 8, wherein the CIS is an enhanced Berkeley Packet Filter (eBPF) instruction set.

10. The device of claim 8, wherein the native instruction set is one of ARM instruction set and an RISC instruction set.

11. The device of claim 8, wherein demoting one or more of the registers to lower size registers comprising demoting one or more 64-bit registers to a 32-bit register.

12. The device of claim 8, wherein the computer program instructions further comprising storing the native instruction set to a just-in-time native virtual machine of the CSD.

13. The device of claim 8, wherein the computer program instructions further comprising optimizing the CIS using frequency of use of the one or more registers of the CIS.

14. The device of claim 13, wherein computer program instructions further comprising optimizing the CIS using at least one of (a) constant folding, (b) load/store optimization, (c) operation strength reduction, and (d) null sequence elimination before generating the native instruction set from the CIS.

15. One or more tangible computer-readable storage media encoding computer-executable instructions for executing on a computer system a computer process, the computer process comprising:
downloading a computation instruction set (CIS) to a computational storage device (CSD);
committing the CIS to a computational storage processor of the CSD;
simulating execution of the CIS to generate static analysis of one or more registers of the CIS to determine ranges of values that the one or more registers can take through a lifecycle of the CIS;
demoting one or more of the registers to lower size registers; and
generating a native instruction set from the CIS based on the register demotions.

16. The one or more tangible computer-readable storage media of claim 15, wherein the CIS is an enhanced Berkeley Packet Filter (eBPF) instruction set.

17. The method of claim 15, wherein the native instruction set is one of ARM instruction set and an RISC instruction set.

18. The method of claim 15, wherein demoting one or more of the registers to lower size registers comprising demoting one or more 64-bit registers to a 32-bit register.

19. The method of claim 15, wherein the computer process further comprising optimizing the CIS using frequency of use of the one or more registers of the CIS.

20. The method of claim 15, wherein the computer process further comprising optimizing the CIS using at least one of (a) constant folding, (b) load/store optimization, (c) operation strength reduction, and (d) null sequence elimination before generating the native instruction set from the CIS.
